(19) United States
(12) Patent Application Publication
(10) Pub. No.: US 2011/0290776 A1
(43) Pub. Date: Dec. 1, 2011

(54) SYSTEM FOR THAWING SNOW OR ICE ON ROAD

(76) Inventor: Sang Man Yoon, Seoul (KR)

(21) Appl. No.: 12/789,174

(22) Filed: May 27, 2010

(51) Int. Cl. H05B 1/00

(52) U.S. Cl. 219/213

(57) ABSTRACT

Provided is a system for preventing snow from piling or freezing into slippery ice on a road in the winter season. The system comprises a case, an antifreeze fluid supply tank installed in an upper portion of the case, an electric heater installed in a lower portion of the case to heat an antifreeze fluid supplied from the antifreeze fluid supply tank, a circulation pump connected between the antifreeze fluid supply tank and the electric heater to supply the antifreeze fluid to the electric heater, an antifreeze fluid discharge pipe connected to one side of the electric heater to discharge the heated antifreeze fluid outside the electric heater therethrough, a synthetic resin hose buried under a road and connected to the antifreeze fluid discharge pipe at one end thereof, and an antifreeze fluid return pipe connected between the other end of the hose and a middle portion of the antifreeze fluid supply tank. Due to this construction, the antifreeze fluid heated by the electric heater is continuously circulated through the hose by the operation of a circulation pump to thaw snow or slippery ice piled on a road.

### BACKGROUND OF THE INVENTION

1. Field of the Invention

The present invention relates to a system for preventing snow from piling or freezing into slippery ice on a road in the winter season. More specifically, the present invention relates to a system constructed in such a manner that an antifreeze fluid as a heat transfer medium is heated by an electric heater and is continuously circulated through a synthetic resin hose buried under a road by the operation of a circulation pump to thaw snow or slippery ice piled on the road.

2. Description of the Related Art

In the winter season, roads are heavily and continuously covered with snow. To clean snow from roads, tools such as brooms and shovels are usually used or snowplow cars are also used. Suitable chemicals (e.g., calcium chloride) capable of melting snow are often sprayed on roads covered with snow. In an attempt to make the use of roads safer, electric heating was developed in which electric heating tubes are buried under roads to thaw snow and slippery ice on the roads.

However, the use of snow cleaning tools such as brooms and shovels is considered as a difficult work because it is labor-consuming. Snowplow cars and chemicals (e.g., calcium chloride) require high costs of use and have the drawback that the use is limited depending on the topography of roads. Electric heating methods suffer from the problems that a large quantity of electricity is consumed and considerable installation costs are incurred. Another problem of electric heating methods is the danger of accidents such as electric leakage and overheating, which causes short circuiting.

### SUMMARY OF THE INVENTION

The present invention has been made in an effort to solve the problems of the prior art, and it is an object of the present invention to provide a system for thawing snow or ice on a road, which is designed in such a manner that an antifreeze fluid is heated by an electric heater and is continuously circulated through a synthetic resin hose buried under the road to heat the surface of the road, that can be installed in an easy manner and can be safely used for a long period of time without the danger of damage and failure.

It is another object of the present invention to provide a system for thawing snow or ice on a road, which is constructed in such a manner that a circulation pump is connected between an antifreeze fluid supply tank installed in an upper portion of a case and an electric heater installed at the bottom of the case and is operated to continuously circulate an antifreeze fluid from the antifreeze fluid supply tank through a hose buried under the road while heating in a heating room of the electric heater, that can be installed in any place in a relatively simple and economical manner and can be safely used without the danger of damage and failure.

According to the present invention, the above objects can be accomplished by the provision of a system for thawing snow or ice on a road, comprising a case, an antifreeze fluid supply tank installed in an upper portion of the case, an electric heater installed in a lower portion of the case to heat an antifreeze fluid supplied from the antifreeze fluid supply tank, a circulation pump connected between the antifreeze fluid supply tank and the electric heater to supply the antifreeze fluid to the electric heater, an antifreeze fluid discharge pipe connected to one side of the electric heater to discharge the heated antifreeze fluid outside the electric heater therethrough, a hose buried under the road and connected to the antifreeze fluid discharge pipe at one end thereof, and an antifreeze fluid return pipe connected between the other end of the hose and a middle portion of the antifreeze fluid supply tank.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating a system for thawing snow or ice on a road, a portion of which is buried under the surface of a road, according to the present invention;

FIG. 2 is a cross-sectional view illustrating the inner portion of the thawing system of FIG. 1;

FIG. 3 is a schematic cross-sectional view of FIG. 2; and

FIG. 4 is a cross-sectional view illustrating a state in which a synthetic resin hose of the thawing system of FIG. 1 is buried under a road.

### DETAILED DESCRIPTION OF THE INVENTION

Preferred embodiments of the present invention will now be described in detail with reference to the accompanying drawings.

It should be noted that whenever possible, the same reference numerals will be used throughout the drawings and the description to refer to the same or like parts. In describing the present invention, detailed descriptions of related known functions or configurations are omitted in order to avoid making the essential subject of the invention unclear.

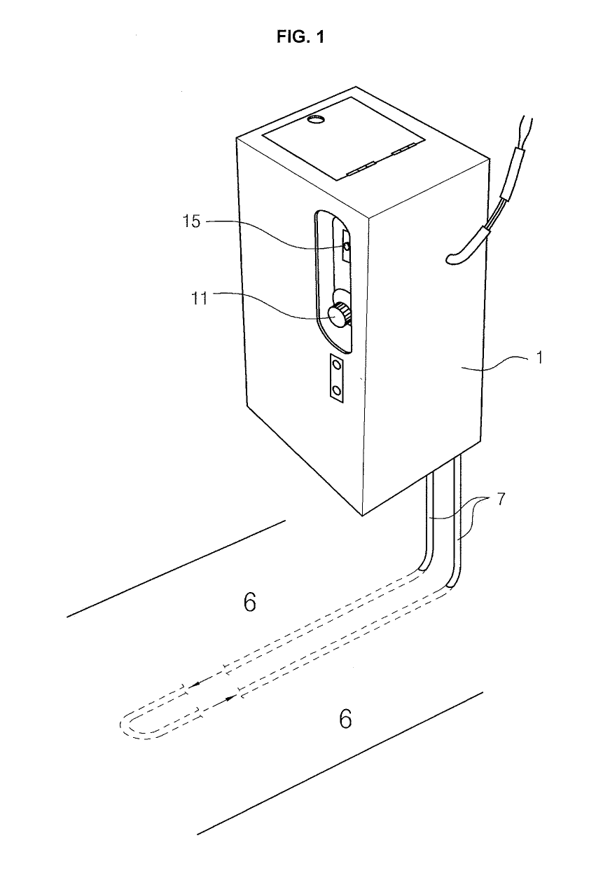

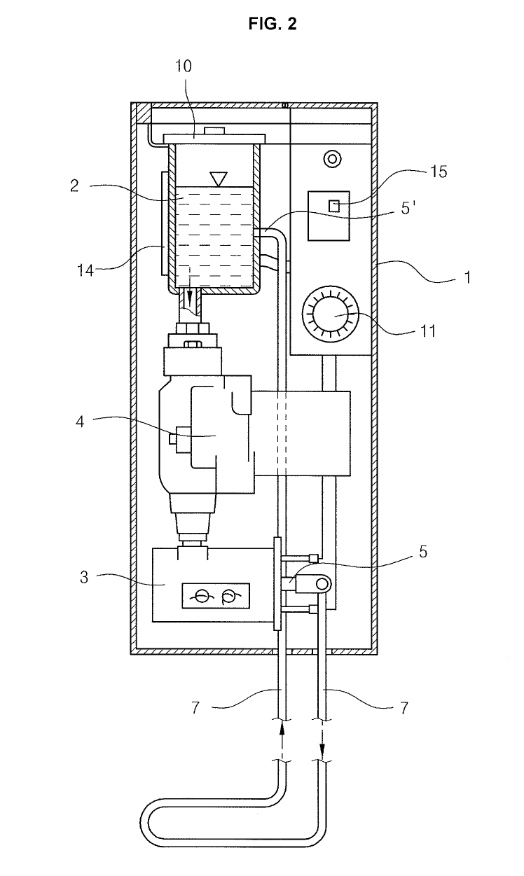

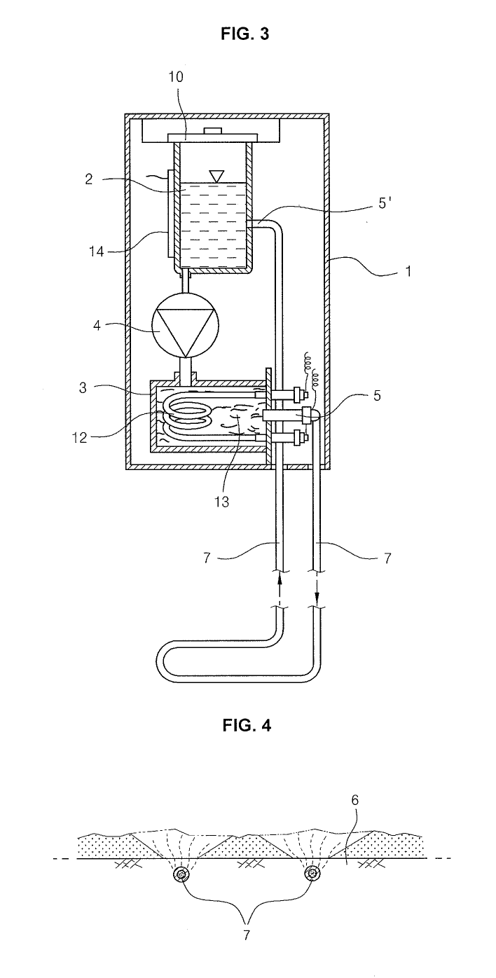

FIG. 1 is a perspective view illustrating a system for thawing snow or ice on a road, a portion of which is buried under the surface of a road, according to the present invention, FIG. 2 is a cross-sectional view illustrating the inner portion of the thawing system, FIG. 3 is a schematic cross-sectional view of the thawing system, and FIG. 4 is a cross-sectional view illustrating a state in which a synthetic resin hose of the thawing system is buried under a road.

As illustrated in FIGS. 1 through 4, an antifreeze fluid supply tank 2 covered with a lid 10 is installed in an upper portion of a case 1, a tank type electric heater 3 is installed in a lower portion of the case 1 and has a heating room 13 in which an electric heating tube 12 is installed, and a circulation pump 4 is laterally installed to connect the antifreeze fluid supply tank 2 and the electric heater 3. Due to this construction, an antifreeze fluid present within the antifreeze fluid supply tank 2 can be smoothly supplied to the heating room 13 of the electric heater 3 by the operation of the circulation pump 4.

One end of a hose 7 buried under a road 6 is connected to an antifreeze fluid discharge pipe 5, which is connected to a lateral side of the electric heater 3, and the other end thereof is connected to an antifreeze fluid return pipe 5′, which is connected to an middle portion of the antifreeze fluid supply tank 2.

A temperature sensor 14 is attached to the outer wall of the antifreeze fluid supply tank 2 to sense the temperature of the antifreeze fluid supply tank 2. A temperature controller 11 controls the temperature sensed by the temperature sensor 14.

Unexplained reference numeral 15 represents a switch.

The antifreeze fluid is injected into the antifreeze fluid supply tank 2 and a power is supplied to the electric heating tube 12 of the electric heater 3 to operate the thawing system.

The circulation pump 4 is operated to supply the antifreeze fluid from the antifreeze fluid supply tank 2 to the heating room 13 where the antifreeze fluid is heated by the electric heating tube 12. The heated antifreeze fluid is supplied to the hose 7 buried under the surface of the road 6 through the antifreeze fluid discharge pipe 5 to heat the surface of the road 6, and as a result, snow or ice on the road 6 is melted. Continuous operation of the circulation pump 4 returns the antifreeze fluid to the antifreeze fluid supply tank 2 through the antifreeze fluid return pipe 5′ connected to a middle portion of the antifreeze fluid supply tank 2. This circulation is repeated to enable continuous thawing of snow or ice on the road. By the use of the thawing system according to the present invention, snow or ice on the road can be thawed in a convenient manner.

As is apparent from the above description, a new antifreeze fluid can be filled in the antifreeze fluid supply tank 2 through the openable lid 10. The heating temperature of the antifreeze fluid is manually controlled by the temperature controller 11. The antifreeze fluid is heated by the electric heating tube 12 fixedly installed in the heating room 13 of the electric heater 3 and is continuously circulated through the synthetic resin hose 7 buried under the road 6 by the operation of the circulation pump 4 to heat the surface of the road 6. This construction enables repeated thawing of snow or ice piled on the road 6 to allow for safe use of the road.

In addition, the thawing system of the present invention can be installed in a simple and economical manner and is easy to use without damage and failure for a long period of time. Therefore, the thawing system of the present invention can be conveniently used by anyone.

Although the present invention has been described herein with reference to the foregoing embodiments and the accompanying drawings, the scope of the present invention is not limited to the embodiments and drawings. Therefore, it will be evident to those skilled in the art that various substitutions, modifications and changes are possible, without departing from the scope and spirit of the invention as disclosed in the accompanying claims.

What is claimed is:

1. A system for thawing snow or ice on a road, comprising a case, an antifreeze fluid supply tank installed in an upper portion of the case, an electric heater installed in a lower portion of the case to heat an antifreeze fluid supplied from the antifreeze fluid supply tank, a circulation pump connected between the antifreeze fluid supply tank and the electric heater to supply the antifreeze fluid to the electric heater, an antifreeze fluid discharge pipe connected to one side of the electric heater to discharge the heated antifreeze fluid outside the electric heater therethrough, a hose buried under the road and connected to the antifreeze fluid discharge pipe at one end thereof, and an antifreeze fluid return pipe connected between the other end of the hose and a middle portion of the antifreeze fluid supply tank.
